(19) United States
(12) Patent Application Publication
(10) Pub. No.: US 2011/0000343 A1
(43) Pub. Date: Jan. 6, 2011

(54) WRENCH WITH RATCHET

(76) Inventor: Duck Hyun NAM, Seoul (KR)

Correspondence Address: Jason Y. Pahng and Associates, LLC, 12178 Bridgend Run, Fairfax, VA, 22030, US

(21) Appl. No.: 12/577,221

(22) Filed: Oct. 12, 2009

(30) Foreign Application Priority Data
Jul. 6, 2009 (KR) 10-2009-0061205

(51) Int. Cl. B25B 13/36

(52) U.S. Cl. 81/90.3

(57) ABSTRACT

A wrench with a ratchet, including: a handle held by a user; and a head coupled to the handle and accommodating and contacting a body to be rotated, wherein the head includes: a base portion connected to one end of the handle; a first jaw extending from a first end of the base portion and including a hanging portion; and a second jaw extending from a second end of the base portion and having a shape corresponding to the first jaw, and wherein a first ratchet member which is adjacent to the hanging portion and of which a portion is moved between an inside and an outside of a rotational path of the body to be rotated that is accommodated in the head.

### CROSS-REFERENCE TO RELATED PATENT APPLICATIONS

This application claims the benefit of Korean Patent Application No. 10-2009-0061205, filed on Jul. 6, 2009, in the Korean Intellectual Property Office, the disclosure of which is incorporated herein in its entirety by reference.

### BACKGROUND OF THE INVENTION

1. Field of the Invention

The present invention relates to a wrench with a ratchet, and more particularly, to a wrench with a ratchet, which is capable of smoothly performing an operation of tightening a bolt or nut even when the wrench is rotated at a small angle.

2. Description of the Related Art

Wrenches are tools used to tighten or loosen bolts, nuts or the like, which are generally used when mechanical components are assembled or disassembled, and are also called spanners. Wrenches are classified into open type wrenches and closed type wrenches according to the shape of their heads, and open type wrenches are classified into single open type wrenches and double open type wrenches. Specifically, the bolt or nut is tightened when a wrench is turned in one direction, and is loosened when the wrench is turned in an opposite direction.

In general, wrenches include a handle and a head. The handle is a type of bar that can be held by a user. The head includes a base portion that extends from one end of the handle and first and second jaws that extend in parallel from both ends of the base portion to face each other.

In regard to such a wrench, if a space sufficient to allow full 360° rotation of the handle is not available when the bolt or nut is tightened or loosened by being turned in the appropriate direction, a rotational stroke must be applied to the bolt or nut several times, and after each stroke is applied to the bolt or nut, the wrench must be repeatedly detached from the bolt or nut and returned to the initial position so as to apply another stroke.

In order to overcome the inconvenience of having to detach the wrench from the bolt or nut when a user applies sequential strokes in a particular direction, a ratchetable open type wrench (Korean Laid-open Patent Publication No. 10-2006-0035783) has been developed.

FIG. 1 illustrates a conventional wrench 1. Referring to FIG. 1, the conventional wrench 1 includes a first jaw 17 and a second jaw 18 that are connected to a base area 19. The wrench 1 further includes a sliding-movement type retractable jaw member 11 within a slot (21, not shown in FIG. 1) that follows a line of a movement axis parallel to a support surface 31 of the second jaw 18. A cover plate 23 is installed in a concave portion of the second jaw 18 and limits transverse movement of the retractable jaw member 11 within the slot (21, not shown in FIG. 1). The cover plate 23 is welded to the second jaw 18 so that a load-supporting structure may be formed in the second jaw 18.

FIG. 2 is a plan view of an end of the wrench 1 including the jaw member 11. The wrench 1 engages with a bolt, thus allowing a user to perform a predetermined tightening operation. Specifically, when the wrench 1 is turned in one direction, the position of the jaw member 11 is fixed, and simultaneously, the bolt is held by the wrench 1 due to an inner surface of the first jaw 17 and the jaw member 11 and thus can be rotated as the wrench 1 is turned. On the other hand, when the wrench 1 is turned in an opposite direction, the jaw member 11 withdraws so that the bolt remains in a fixed state while the wrench 1 is turned. After that, when the wrench 1 is turned again in the tightening direction, the bolt is held by the wrench 1 again due to the inner surface of the first jaw 17 and the jaw member 11 and simultaneously is rotated as the wrench 1 is turned.

However, the conventional wrench 1 has the following drawbacks.

In the conventional wrench 1, an edge of the bolt contacts the inner surface of the first jaw 17 and the jaw member 11 and thus, the bolt is held by the wrench 1. In other words, when the wrench 1 is turned in one direction, an operation of tightening the bolt is performed and the wrench 1 is turned in an opposite direction so that the bolt can held by the wrench 1 during the next tightening stroke, the wrench 1 must pass by at least the next edge of the bolt. In other words, in the case of a hexagonal bolt, the wrench 1 must be turned at least angle, such as 60° (α in FIG. 2) or more in an opposite direction so that an edge of the hexagonal bolt can held by the wrench 1 and then the bolt can be held by the wrench 1 during the next tightening stroke, and then the wrench 1 must be turned again in the tightening direction so that the bolt can be tightened.

The rotational angle of 60° does not matter when a large working space is available. However, when the wrench 1 is used in a confined working space, an operation of tightening the bolt may not be smoothly performed.

### SUMMARY OF THE INVENTION

The present invention provides a wrench with a ratchet, which is capable of smoothly performing an operation of tightening a bolt or nut even when the wrench is turned at a small angle.

According to an aspect of the present invention, there is provided a wrench with a ratchet, the wrench including: a handle held by a user; and a head coupled to the handle and accommodating and contacting a body to be rotated, wherein the head includes: a base portion connected to one end of the handle; a first jaw extending from a first end of the base portion and including a hanging portion; and a second jaw extending from a second end of the base portion and having a shape corresponding to the first jaw, and wherein a first ratchet member which is adjacent to the hanging portion and of which a portion is moved between an inside and an outside of a rotational path of the body to be rotated that is accommodated in the head, and a first elastic member elastically pressurizing the portion of the first ratchet member so that the portion of the first ratchet member is moved to the inside of the rotational path of the body to be rotated, are coupled to the first jaw, and a second ratchet member of which a portion is moved between the inside and the outside of the rotational path of the body to be rotated, and a second elastic member elastically pressurizing the portion of the second ratchet member so that the portion of the second ratchet member is moved to the inside of the rotational path of the body to be rotated, are coupled to the second jaw, and when the head is rotated in one direction, the body to be rotated is confined by the hanging portion and the second ratchet member so that the body to be rotated is rotated together with the head, and when the head is rotated in an opposite direction to the one direction and then is rotated again in the one direction, the body to be rotated is confined due to the first ratchet member and the second ratchet member and is rotated together with the head.

A first surface may be formed on the hanging portion so that the body to be rotated is confined by the first surface, and a second surface may be formed on the first ratchet member so that the body to be rotated is confined by the second surface, and a third surface and a fourth surface may be formed on the second ratchet member and may be parallel to the first surface and the second surface, respectively, so that the body to be rotated is confined by the third surface or the fourth surface.

The first ratchet member may include: a first ratchet body of which a portion contacts the body to be rotated; and a first ratchet housing rotatably coupled to one end of the first ratchet body and including a first accommodation space in which the first ratchet body is accommodated, and wherein the first elastic member is disposed in the first accommodation space, and a first end of the first elastic member contacts the first ratchet housing, and a second end thereof contacts the first ratchet body.

A circular jaw having a circular cross-section may be formed on the end of the first ratchet housing, and a circular inner surface having a shape corresponding to an outer surface of the circular jaw and sliding along the outer surface of the circular jaw may be formed in the first ratchet body.

A first groove may be formed in an inner surface of the first jaw, and the first ratchet housing may be coupled to the first groove and can be attached thereto or detached therefrom.

A hanging jaw may be formed on an end of the first ratchet body, and a hanging portion may be formed on the first ratchet housing to limit a rotational angle of the first ratchet body as the hanging portion is coupled to the hanging jaw.

A through hole may be formed in the second jaw in a predetermined direction, and the second ratchet member may be inserted in the through hole and moves in the predetermined direction, and a first end of the second elastic member may be supported by a closing member closing the through hole, and a second end thereof may elastically pressurize the second ratchet member while contacting the second ratchet member.

A second groove may be formed in the second jaw, and a second accommodation space may be formed in the second ratchet housing and extends in a predetermined direction inside the second ratchet housing, and the second ratchet member may be inserted in the second accommodation space so that the second ratchet housing that is slidable can be attached to or detached from the second accommodation space, and the second elastic member may be disposed in the second accommodation space and may elastically pressurize the second ratchet member while a first end of the second elastic member contacts the second ratchet housing and a second end of the second elastic member contacts the second ratchet member.

A stepped portion having a shape corresponding to the body to be rotated so that the body to be rotated may be confined by at least one of the first ratchet member and the second ratchet member.

According to another aspect of the present invention, there is provided a wrench with a ratchet, the wrench including: a handle held by a user; and a head coupled to the handle and accommodating and contacting a body to be rotated, wherein the head comprises: a base portion connected to one end of the handle; a first jaw extending from a first end of the base portion and comprising a hanging portion; and a second jaw extending from a second end of the base portion and having a shape corresponding to the first jaw, and wherein the hanging portion comprises a first hanging portion and a second hanging portion which is adjacent to the first portion hanging portion, and a second ratchet member of which a portion is moved between the inside and the outside of a rotational path of the body to be rotated that is accommodated in the head, and a second elastic member elastically pressurizing the portion of the second ratchet member so that the portion of the second ratchet member is moved to the inside of the rotational path of the body to be rotated, are coupled to the second jaw, and when the head is rotated in one direction, the body to be rotated is confined by the first hanging portion and the second ratchet member so that the body to be rotated is rotated together with the head, and when the head is rotated in an opposite direction to the one direction and then is rotated again in the one direction, the body to be rotated is confined due to the second hanging portion and the second ratchet member and is rotated together with the head.

The minimum rotational angle of the wrench to rotate a body to be rotated may be 20°˜45°.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a conventional wrench;

FIG. 2 is a plan view of the conventional wrench shown in FIG. 1;

FIG. 3 illustrates a wrench with a ratchet, according to an embodiment of the present invention;

FIG. 4 is an exploded view of the wrench with the ratchet shown in FIG. 3;

FIGS. 5 through 7 illustrate operations of the wrench with the ratchet of FIG. 3; and

FIG. 8 through 13 illustrate a wrench with a ratchet, according to another embodiment of the present invention.

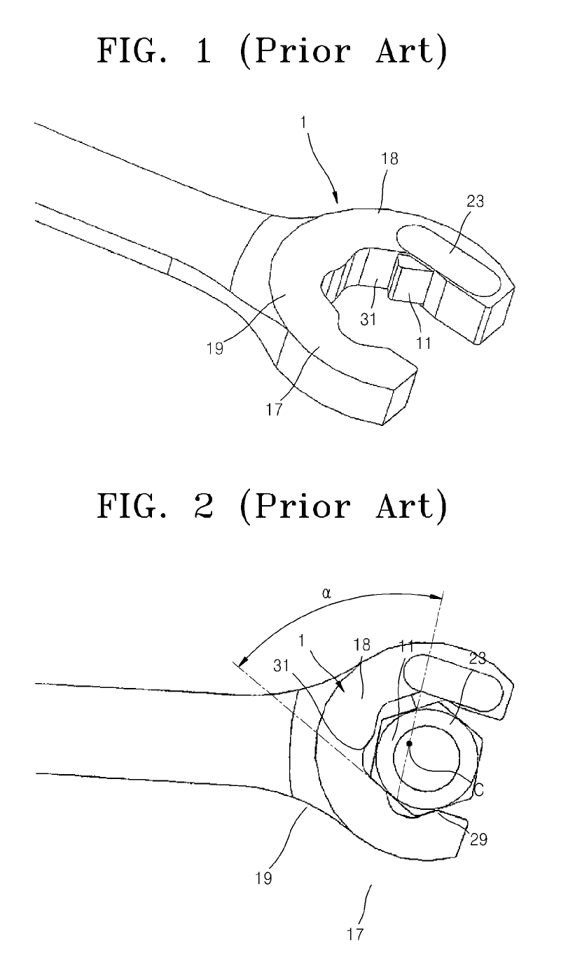

### DETAILED DESCRIPTION OF THE INVENTION

The present invention will now be described more fully with reference to the accompanying drawings, in which exemplary embodiments of the invention are shown.

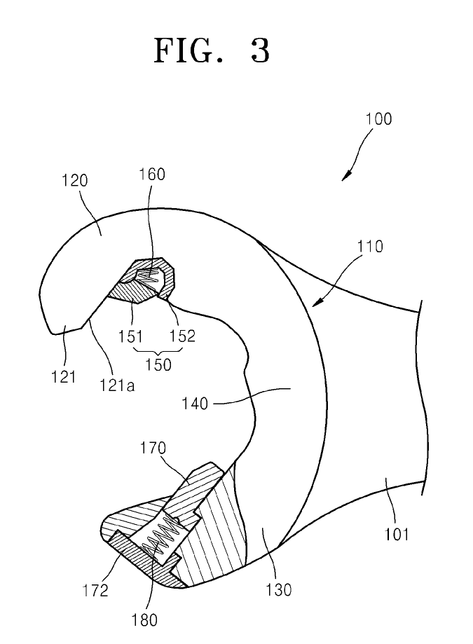

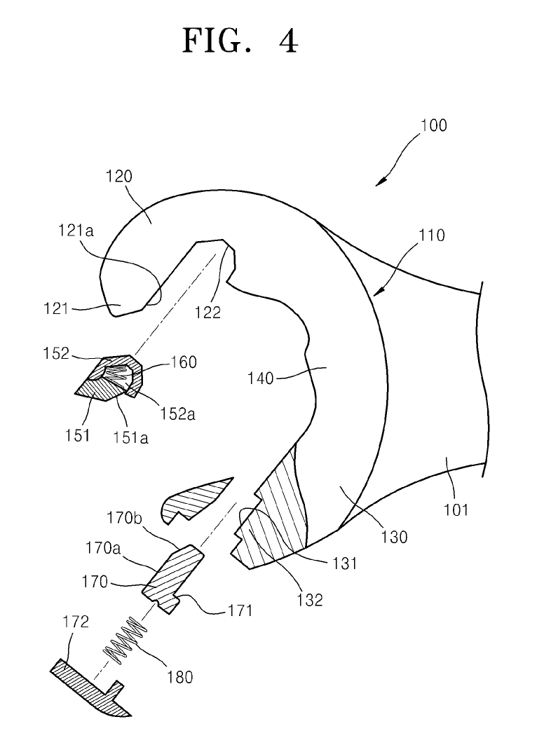

FIG. 3 illustrates a wrench 100 with a ratchet, according to an embodiment of the present invention, and FIG. 4 is an exploded view of the wrench 100 with the ratchet shown in FIG. 3.

Referring to FIG. 3, the wrench 100 with the ratchet, according to the present embodiment, includes a handle 101 and a head 110. The head 110 includes a first jaw 120, a second jaw 130, a first ratchet member 150, a first elastic member 160, a second ratchet member 170, and a second elastic member 180.

The handle 101 has a shape of a bar that can be held by a user and extends from the head 110 in a particular direction. The handle 101 may be formed of a high-hardness metallic material. However, the present invention is not limited thereto, and the handle 101 may be formed of various materials.

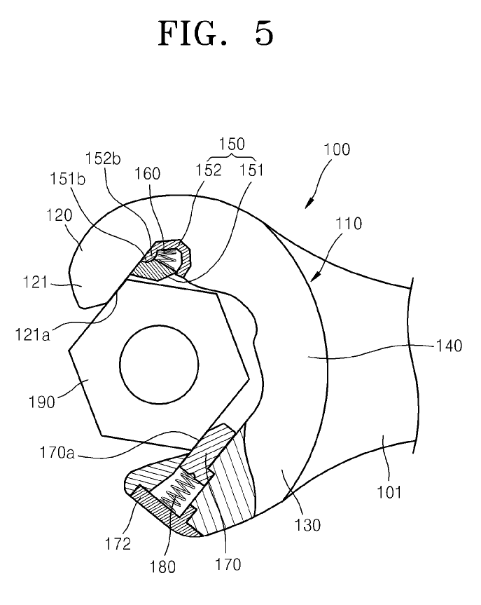

The head 110 and the handle 101 are manufactured as one body by performing a casting process, and a body to be rotated such as 190 of FIG. 5, such as a bolt or nut, is accommodated in the head 110 and contacts the head 110. The head 110 has a “C”-shape with an opening formed at one end. The head 110 includes the first jaw 120, the second jaw 130, and a base portion 140.

The base portion 140 is formed opposite to the open end of the head 110 and extends from an end of the handle 101.

The first jaw 120 and the second jaw 130 extend in parallel from both ends of the base portion 140 to face each other. The first jaw 120 and the second jaw 130 may have the same shape or may have different shapes if necessary. Meanwhile, the first jaw 120 and the second jaw 130 have a circular shape or an oval shape. A body to be rotated such as 190 of FIG. 5, such as a bolt or nut inserted through an opening, is accommodated in a space formed by inner surfaces of the base portion 140, the first jaw 120, and the second jaw 130 so that the first jaw 120 and the second jaw 130 may be engaged with the body to be rotated such as 190 of FIG. 5.

In this case, a hanging portion 121 and a first groove 122 are formed in the first jaw 120. The hanging portion 121 is formed to be near an end of the first jaw 120 and protrudes inwards from the first jaw 120. A first surface 121a is formed on the hanging portion 121 so that the body to be rotated such as 190 of FIG. 5 may be confined by the first surface 121a. Specifically, the first surface 121a contacts the body to be rotated such as 190 of FIG. 5 so that the body to be rotated such as 190 of FIG. 5 and the second ratchet member 170, which will be described later, may be confined by the first surface 121a. The first surface 121a may face the base portion 140.

The first ratchet member 150 and the first elastic member 160 are inserted in the first groove 122. The first groove 122 is adjacent to the hanging portion 121 and is recessed from the inner surface of the first jaw 120 toward an outer surface thereof.

A through hole 131 is formed in the second jaw 130 toward the base portion 140 from an end of the second jaw 130. A hanging jaw portion 132 is formed in an inner circumferential surface of the through hole 131 and protrudes inwards from the second jaw 130. The hanging jaw portion 132 prevents the second ratchet member 170, which is inserted therein, from being completely separated from the through hole 131.

The first ratchet member 150 is adjacent to the hanging portion 121 and confines the body to be rotated such as 190 of FIG. 5 while contacting an outer circumferential surface of the body to be rotated such as 190 of FIG. 5. Specifically, a portion of the first ratchet member 150 is moved between the inside and outside of a rotational path of the body to be rotated such as 190 of FIG. 5 accommodated in the head 110. In this case, rotation of the body to be rotated such as 190 of FIG. 5 by which the portion of the first ratchet member 150 is moved to the inside of the rotational path of the body to be rotated such as 190 of FIG. 5, is prevented so that a body to be rotated such as 190 of FIG. 5 and the head 110 may be simultaneously rotated as one body. In this case, the first ratchet member 150 is pressurized and fixed due to a pressurizing force of a body to be rotated such as 190 of FIG. 5 when contacting the body to be rotated such as 190 of FIG. 5, and the body to be rotated such as 190 of FIG. 5 is confined by the first ratchet member 150. Meanwhile, a surface of the first ratchet member 150 that contacts the body to be rotated such as 190 of FIG. 5 so that the body to be rotated such as 190 of FIG. 5 may be confined is referred to as a second surface 151a.

Meanwhile, the first ratchet member 150 includes a first ratchet body 151 and a first ratchet housing 152. A portion of the first ratchet body 151 contacts the body to be rotated such as 190 of FIG. 5, and the second surface 151a is formed on the first ratchet body 151.

The first ratchet housing 152 is rotatably coupled to an end of the first ratchet body 151. Specifically, a circular jaw 152b having a circular cross-section is formed on the end of the first ratchet housing 152, and a circular inner surface 151b having a shape corresponding to an outer surface of the circular jaw 152b is formed in the first ratchet body 151. As the circular inner surface 151b of the first ratchet body 151 slides in contact with the outer surface of the circular jaw 152b of the first ratchet housing 152, the first ratchet body 151 may be rotated clockwise or counterclockwise. In this case, a portion of the first ratchet body 151 is moved between the inside and outside of the rotational path of the body to be rotated such as 190 of FIG. 5. A first accommodation space 152a is formed in the first ratchet housing 152 so that the rotating first ratchet body 151 may be accommodated in the first accommodation space 152a. The first ratchet housing 152 may be detachably coupled to the first groove 122.

The first elastic member 160 elastically pressurizes the portion of the first ratchet member 150 so that the portion of the first ratchet member 150 may be moved to the inside of the rotational path of the body to be rotated such as 190 of FIG. 5. A compressive coil spring is used as the first elastic member 160. However, the present invention is not limited thereto, and a planar spring may be used as the first elastic member 160 and any appropriate elastic material may be used in the first elastic member 160. Meanwhile, the first elastic member 160 is disposed in the first accommodation space 152a, and a first end of the first elastic member 160 contacts the first ratchet housing 152, and a second end of the first elastic member 160 contacts the first ratchet body 151.

A portion of the second ratchet member 170 is moved between the inside and outside of the rotational path of the body to be rotated such as 190 of FIG. 5. Specifically, the second ratchet member 170 is inserted in the through hole 131 of the second jaw 130 and moves along an inside of the through hole 131. The second ratchet member 170 has the shape of a pin that has a rectangular cross-section and extends in a particular direction. A portion of the second ratchet member 170 is inserted in the first jaw 120, and the other portion thereof is exposed to the outside and thus may contact the body to be rotated such as 190 of FIG. 5. A ratchet hanging portion 171 that corresponds to the hanging jaw portion 132 disposed in the through hole 131 is formed at the second ratchet member 170. As the ratchet hanging portion 171 is coupled to the hanging jaw portion 132, the first ratchet member 150 is prevented from being completely separated from the through hole 131.

A third surface 170a is formed on the second ratchet member 170 and is parallel to the first surface 121a. A fourth surface 170b is also formed on the second ratchet member 170 and is parallel to the second surface 151a. The body to be rotated such as 190 of FIG. 5, which is accommodated in the head 110, is held by the head 110 as it contacts the first surface 121a and the third surface 170a or the second surface 151a and the fourth surface 170b, respectively.

The second elastic member 180 elastically pressurizes the portion of the second ratchet member 170 so that the portion of the second ratchet member 170 may be moved to the inside of the rotational path of the body to be rotated such as 190 of FIG. 150. A first end of the second elastic member 180 is supported by a closing member 172 that closes the through hole 131, and a second end of the second elastic member 180 contacts the second ratchet member 170 and elastically pressurizes the second ratchet member 170. A compressive coil spring may be used as the second elastic member 180. However, the present invention is not limited thereto, and any appropriate elastic material may be used in the second elastic member 180.

Meanwhile, when the head 110 is rotated in a particular direction, the body to be rotated such as 190 of FIG. 5 is confined by the hanging portion 121 and the second ratchet member 170 and is rotated together with the head 110. On the other hand, when the head 110 is rotated in an opposite direction and then is rotated again in the particular direction, the body to be rotated such as 190 of FIG. 5 is confined by the first ratchet member 150 and the second ratchet member 170 and is rotated together with the head 110.

The wrench with the ratchet shown in FIGS. 3 and 4 operates as described below.

FIGS. 5 through 7 illustrate operations of the wrench with the ratchet of FIG. 3. Referring to FIG. 5, when the body (bolt) 190 to be rotated contacts the first surface 121a of the hanging portion 121 and the third surface 170a of the second ratchet member 170 and the head 110 is rotated in a direction (direction A of FIG. 5), the body 190 to be rotated is rotated as one body with the head 110. In other words, as the body 190 to be rotated is rotated together with the head 110, the body 190 (bolt) to be rotated may be tightened or loosened in a predetermined direction.

In this case, the second ratchet member 170 is pressurized and fixed by the body 190 to be rotated so that the body 190 to be rotated may be confined by the second ratchet member 170 and the hanging portion 121.

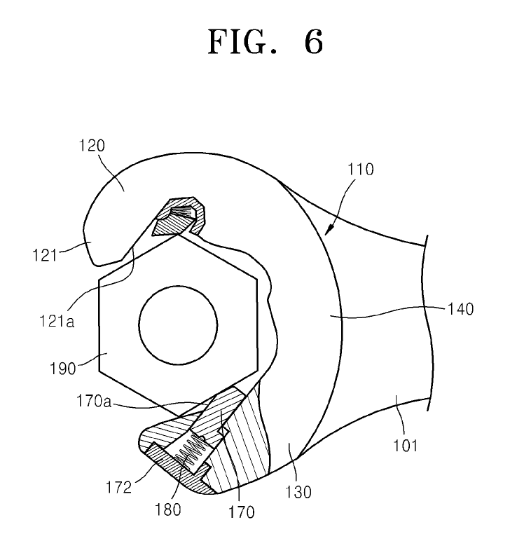

Subsequently, when the head 110 is rotated in an opposite direction (direction B of FIG. 6) to the direction A, relative rotation of the body 190 to be rotated with respect to the head 110 is allowed as the first ratchet member 150 and the second ratchet member 170 move and are deviated from the rotational path of the body 190 to be rotated. In other words, the body 190 to be rotated remains in a fixed state while head 110 is rotated.

After that, when the head 110 is rotated in the direction A, the body 190 to be rotated contacts the second surface 151a of the first ratchet member 150 and the fourth surface 170b of the second ratchet member 170. In this case, positions of the first ratchet member 150 and the second ratchet member 170 are fixed and simultaneously, the body 190 to be rotated is held by the wrench 100. As such, the body 190 to be rotated may be rotated together with the head 110 as one body and may be tightened or loosened.

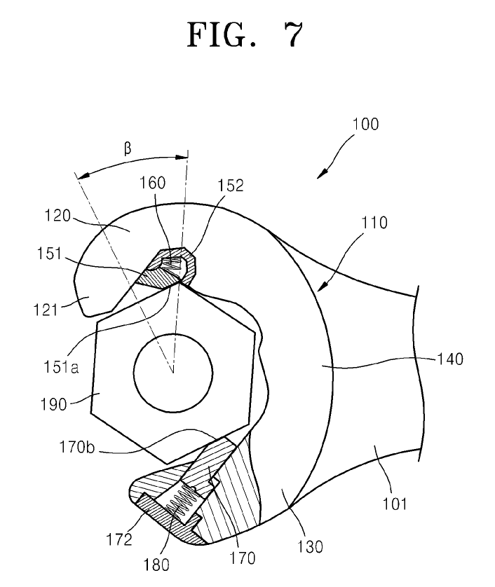

The wrench 100 with the ratchet shown in FIG. 3 has the following effects. First, in the conventional wrench, a portion of a first jaw and a portion of a second jaw contact the body to be rotated so that the body to be rotated may be held by the wrench 100 and may be rotated. However, in the conventional wrench, it is inconvenient to rotate the wrench by an angle of 60° or more in an opposite direction to the direction to tighten a bolt having a hexagonal cross-section. However, in the present embodiment, the first surface 121a and the second surface 151a of the first jaw 120 contact the third surface 170a and the fourth surface 170b of the second jaw 130, respectively, so that an operation of tightening a bolt may be performed twice and a rotational angle of the wrench 100 may be efficiently decreased. In other words, when the wrench 100 is rotated at about 30°, as illustrated in FIG. 7, an edge of the bolt is moved from the first surface 121a to the second surface 151a so that an operation of tightening or loosening the bolt may be performed even at a small rotational angle.

In addition, in the present embodiment, a slide type ratchet member is used in a portion of the second jaw 130 to which a tensile force is applied; however, a pivot-movement ratchet member is used in a portion of the first jaw 120 to which a compressive force is applied so that the space occupied by the wrench 100 may be efficiently used. The pivot type ratchet member has a reduced ability to endure a large load compared to the slide type ratchet member but may be rotated and inserted in the wrench 100 so that a similar function to that of the slide type ratchet member may be performed in a minimum space.

In addition, in the present embodiment, as the third surface 170a and the fourth surface 170b are formed on the second ratchet member 170, one ratchet member may perform an operation of confining the body 190 to be rotated in the wrench 100 twice and thus, it is convenient to use the wrench 100. In other words, in the case of the first jaw 120, the hanging portion 121 and the first ratchet member 150 are used to confine the body 190 to be rotated in the wrench 100; however, the second ratchet member 170 may perform the operation of confining the body 190 to be rotated in the wrench 100 twice by using only one structure so that the entire structure of the wrench 100 may be simplified.

The structure of the wrench 100 with the ratchet shown in FIG. 3 may be changed as follows.

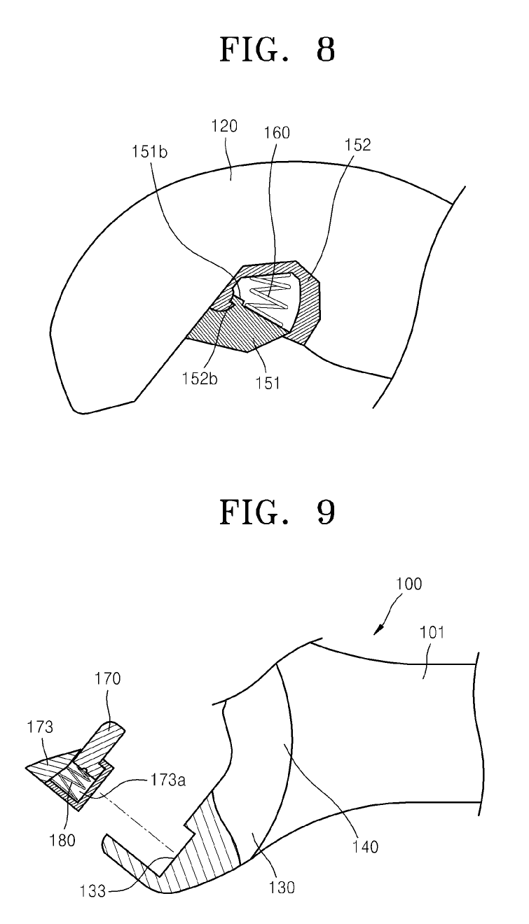

FIG. 8 through 13 illustrate a wrench with a ratchet, according to another embodiment of the present invention.

Referring to FIG. 8, a hanging jaw 151b may be formed on an end of the first ratchet body 151, and a hanging portion 152b may be formed at the first ratchet housing 152 to limit the rotational angle of the first ratchet body 151 as the hanging portion 152b is coupled to the hanging jaw 151b. As the hanging jaw 151b and the hanging portion 152b are coupled to each other, the first ratchet body 151 may be prevented from being rotated a predetermined number of times or more and a space in which a spring is to be inserted may be formed due to the hanging jaw 151b.

Referring to FIG. 9, only a groove is formed in the second jaw 130 while a through hole such as 131 of FIG. 4 is not formed in the second jaw 130 so that the second ratchet member 170 may be coupled to the groove. In other words, a second groove 133 may be formed in the second jaw 130, and the second ratchet housing 173 may be accommodated in the second groove 133. A second accommodation space 173a is formed in the second ratchet housing 173 and extends in a particular direction inside the second ratchet housing 173. The second ratchet member 170 is inserted in the second accommodation space 173a so that the second ratchet housing 173 that is slidable may be attached to or detached from the second accommodation space 173a. The second elastic member 180 is disposed in the second accommodation space 173a and elastically pressurizes the second ratchet member 170 while a first end of the second elastic member 180 contacts the second ratchet housing 173 and a second end of the second elastic member 180 contacts the second ratchet member 170.

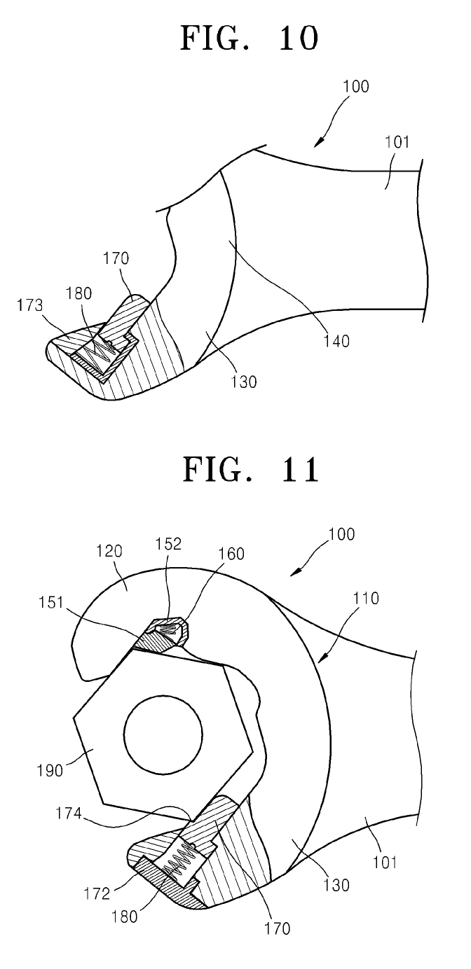

Referring to FIG. 11, a stepped portion 174 by which the body 190 to be rotated may be confined may be formed in the second ratchet member 170. In other words, in FIG. 4, the edge of the second ratchet member 170 is processed so that the body 190 to be rotated contacts the edge of the second ratchet member 170. However, referring to FIG. 10, the stepped portion 174 having a shape corresponding to the edge of the body 190 to be rotated may be formed in the second ratchet member 170, and the body 190 to be rotated may be confined by the stepped portion 174 and thus may be confined by the second ratchet member 170.

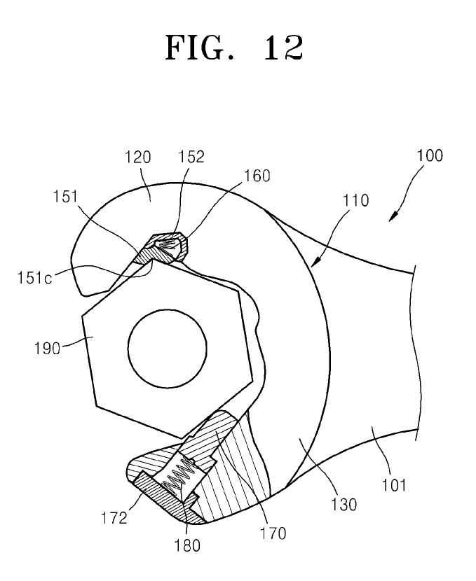

Referring to FIG. 12, a stepped portion 151c by which the body 190 to be rotated may be confined may be formed in the first ratchet member 150. The stepped portion 151c has a shape corresponding to the edge of the body 190 to be rotated and thus, the body 190 to be rotated is accommodated in the stepped portion 151c so that the body 190 to be rotated may be confined by the second ratchet member 170.

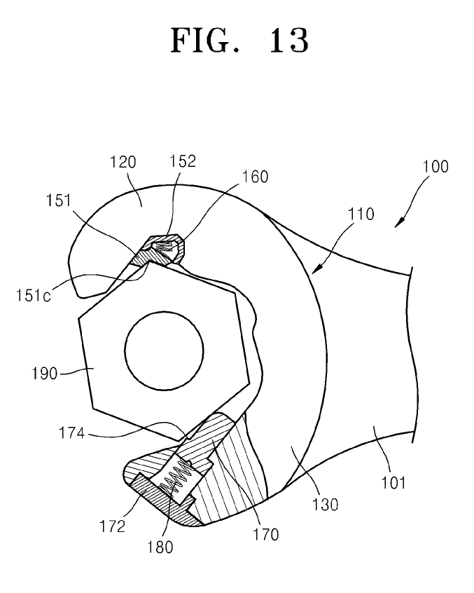

Referring to FIG. 13, the stepped portions 151c and 174 may be formed in the first ratchet member 150 and the second ratchet member 170, respectively. In FIGS. 10 through 12, the number of stepped portions is limited; however, a plurality of stepped portions may be formed in the first ratchet member 150 and the second ratchet member 170, respectively. In this case, the rotational angle of the wrench 100 may be further decreased.

According to another embodiment of the present invention, a first jaw comprises only a hanging portion. And the hanging portion comprises a first hanging portion and a second hanging portion, which is adjacent to the first hanging portion. When the head is rotated in one direction, the body to be rotated is confined by the first hanging portion and the second ratchet member so that the body to be rotated is rotated together with the head, and when the head is rotated in an opposite direction to the one direction and then is rotated again in the one direction, the body to be rotated is confined due to the second hanging portion and the second ratchet member and is rotated together with the head.

As described above, in the wrench with the ratchet, according to the present invention, at least two confinement portions for confining the body to be rotated are disposed in each of first and second jaws so that an operation of tightening the body to be rotated can be efficiently performed even when the body to be rotated has a minimum rotational angle of 20˜45° and preferably about at 30° and a user can easily work even in a small working space.

In addition, one ratchet member of the second jaw corresponds to two confinement portions of the first jaw, and an operation of tightening a bolt can be performed so that the structure of the wrench can be simplified.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A wrench with a ratchet, the wrench comprising:
a handle held by a user; and
a head coupled to the handle and accommodating and contacting a body to be rotated,
wherein the head comprises:
a base portion connected to one end of the handle;
a first jaw extending from a first end of the base portion and comprising a hanging portion; and
a second jaw extending from a second end of the base portion and having a shape corresponding to the first jaw, and
wherein a first ratchet member which is adjacent to the hanging portion and of which a portion is moved between an inside and an outside of a rotational path of the body to be rotated that is accommodated in the head, and a first elastic member elastically pressurizing the portion of the first ratchet member so that the portion of the first ratchet member is moved to the inside of the rotational path of the body to be rotated, are coupled to the first jaw, and
a second ratchet member of which a portion is moved between the inside and the outside of the rotational path of the body to be rotated, and a second elastic member elastically pressurizing the portion of the second ratchet member so that the portion of the second ratchet member is moved to the inside of the rotational path of the body to be rotated, are coupled to the second jaw, and
when the head is rotated in one direction, the body to be rotated is confined by the hanging portion and the second ratchet member so that the body to be rotated is rotated together with the head, and
when the head is rotated in an opposite direction to the one direction and then is rotated again in the one direction, the body to be rotated is confined due to the first ratchet member and the second ratchet member and is rotated together with the head.

2. The wrench of claim 1, wherein a first surface is formed on the hanging portion so that the body to be rotated is confined by the first surface, and a second surface is formed on the first ratchet member so that the body to be rotated is confined by the second surface, and a third surface and a fourth surface are formed on the second ratchet member and are parallel to the first surface and the second surface, respectively, so that the body to be rotated is confined by the third surface or the fourth surface.

3. The wrench of claim 1, wherein the first ratchet member comprises:
a first ratchet body of which a portion contacts the body to be rotated; and
a first ratchet housing rotatably coupled to one end of the first ratchet body and comprising a first accommodation space in which the first ratchet body is accommodated, and
wherein the first elastic member is disposed in the first accommodation space, and a first end of the first elastic member contacts the first ratchet housing, and a second end thereof contacts the first ratchet body.

4. The wrench of claim 3, wherein a circular jaw having a circular cross-section is formed on the end of the first ratchet housing, and a circular inner surface having a shape corresponding to an outer surface of the circular jaw and sliding along the outer surface of the circular jaw is formed in the first ratchet body.

5. The wrench of claim 1, wherein a first groove is formed in an inner surface of the first jaw, and the first ratchet housing is coupled to the first groove and can be attached thereto or detached therefrom.

6. The wrench of claim 3, wherein a hanging jaw is formed on an end of the first ratchet body, and a hanging portion is formed on the first ratchet housing to limit a rotational angle of the first ratchet body as the hanging portion is coupled to the hanging jaw.

7. The wrench of claim 1, wherein a through hole is formed in the second jaw in a predetermined direction, and the second ratchet member is inserted in the through hole and moves in the predetermined direction, and a first end of the second elastic member is supported by a closing member closing the through hole, and a second end thereof elastically pressurizes the second ratchet member while contacting the second ratchet member.

8. The wrench of claim 1, wherein a second groove is formed in the second jaw, and a second accommodation space is formed in the second ratchet housing and extends in a predetermined direction inside the second ratchet housing, and the second ratchet member is inserted in the second accommodation space so that the second ratchet housing that is slidable can be attached to or detached from the second accommodation space, and the second elastic member is disposed in the second accommodation space and elastically pressurizes the second ratchet member while a first end of the second elastic member contacts the second ratchet housing and a second end of the second elastic member contacts the second ratchet member.

9. The wrench of claim 1, wherein a stepped portion having a shape corresponding to the body to be rotated so that the body to be rotated is confined by at least one of the first ratchet member and the second ratchet member.

10. A wrench with a ratchet, the wrench comprising:
a handle held by a user; and
a head coupled to the handle and accommodating and contacting a body to be rotated,
wherein the head comprises:
a base portion connected to one end of the handle;
a first jaw extending from a first end of the base portion and comprising a hanging portion; and
a second jaw extending from a second end of the base portion and having a shape corresponding to the first jaw, and
wherein the hanging portion comprises a first hanging portion and a second hanging portion which is adjacent to the first portion hanging portion, and
a second ratchet member of which a portion is moved between the inside and the outside of a rotational path of the body to be rotated that is accommodated in the head, and a second elastic member elastically pressurizing the portion of the second ratchet member so that the portion of the second ratchet member is moved to the inside of the rotational path of the body to be rotated, are coupled to the second jaw, and
when the head is rotated in one direction, the body to be rotated is confined by the first hanging portion and the second ratchet member so that the body to be rotated is rotated together with the head, and
when the head is rotated in an opposite direction to the one direction and then is rotated again in the one direction, the body to be rotated is confined due to the second hanging portion and the second ratchet member and is rotated together with the head.

11. The wrench of claim 1, wherein the minimum rotational angle of the wrench to rotate a body to be rotated is 20°˜45°.
